(19) United States
(12) Patent Application Publication
(10) Pub. No.: US 2025/0161881 A1
(43) Pub. Date: May 22, 2025

(54) SEPARATE TYPE BOTTLE TOP FILTER DEVICE

(71) Applicant: UMTR CO. LTD., Seoul (KR)

(72) Inventors: Sung Ryul PARK, Seoul (KR); Hye Min SUNG, Seoul (KR); Joon Bum PARK, Seoul (KR); Dong Min KIM, Paju-si (KR); Tae Hwan KWON, Seoul (KR); So Young MOON, Seoul (KR); Hyo Gil JANG, Seoul (KR); Jae Hyun YOO, Seoul (KR)

(73) Assignee: UMTR CO. LTD., Seoul (KR)

(21) Appl. No.: 18/409,338

(22) Filed: Jan. 10, 2024

Related U.S. Application Data
(63) Continuation of application No. PCT/KR2023/019511, filed on Nov. 30, 2023.

(30) Foreign Application Priority Data
Nov. 16, 2023 (KR) 10-2023-0159499

(51) Int. Cl. B01D 63/08; B01D 69/10

(52) U.S. Cl. CPC B01D 63/087; B01D 69/10; B01D 2221/02; B01D 2313/025

(57) ABSTRACT

Provided is a separate type bottle top filter device which includes: a first coupling body in which an internal space receiving a sample is provided therein, and a discharge port through which the sample is discharged is formed; a second coupling body removably coupled to a lower portion of the first coupling body, and having a discharge member for discharging the sample discharged through the first discharge port to one side; and a membrane filter installed between the first and second coupling bodies to filter a target substance included in the sample discharged by the discharge member.

### CROSS-REFERENCE TO RELATED APPLICATIONS

This application is a continuation of International Patent Application No. PCT/KR2023/019511, filed on Nov. 30, 2023, which claims the priority of Korean Patent Application No. 10-2023-0159499 filed on Nov. 16, 2023, in the Korean Intellectual Property Office, the disclosure of which is incorporated herein by reference.

### BACKGROUND OF THE INVENTION

### Field of the Invention

The present invention relates to a separate type bottle top filter device, and more particularly, to a separate type bottle top filter device which includes a membrane filter, and is removably coupled to multiple components.

### Description of the Related Art

A Filter device is a device that filters solid particles contained in a liquid sample or separates some of the substances that make up the liquid sample, and various filter devices are developed in order to increase filtering efficiency, a filtering speed, stability, etc.

Such a conventional filter device is constituted by a rubber stopper blocking an inlet of a recovery container containing a filtered sample, a funnel in which a sample container containing a sample which is not filtered is coupled to an upper portion and a lower portion is inserted into a fastening hole provided in the rubber stopper, and fastened and fixed, a filter provided on an inner peripheral surface of the funnel, a fixation plate preventing the filter from being in close contact with a lower opening portion, and a vacuum pump suctioning air in the recovery container via a vacuum hose inserted into a hole provided at an upper portion of the recovery container.

However, in the conventional filter device, since a funnel installed with a filter is integrally formed, when a fault occurs in a part, the entirety of the filter device should be replaced, and the filter is not easily replaced.

### SUMMARY OF THE INVENTION

The present invention is contrived to improve the problem, and has been made in an effort to provide a separate type bottle top filter device constituted by first and second coupling bodies, and a membrane filter which are coupled removably from each other.

In order to achieve the object, provided is a separate type bottle top filter device which includes: a first coupling body in which an internal space receiving a sample is provided therein, and a discharge port through which the sample is discharged is formed; a second coupling body removably coupled to a lower portion of the first coupling body, and having a discharge member for discharging the sample discharged through the first discharge port to one side; and a membrane filter installed between the first and second coupling bodies to filter a target substance included in the sample discharged by the discharge member.

The second coupling body is formed in which an insertion space of which upper portion is opened is formed therein so that the lower portion of the first coupling body is fitted.

The first coupling body is formed in an insertion groove on an outer peripheral surface of a lower portion inserted into the first coupling body, and the second coupling body has an insertion protrusion formed on an inner peripheral surface so as to be inserted into the insertion groove when the first coupling body is inserted into the insertion space.

The first coupling body is formed so that an upper part of the insertion groove has an outer diameter smaller than an inner diameter of the second coupling body to be easily inserted by the second coupling body.

The first coupling body has a closed protrusion portion formed on the outer peripheral surface so as to close a space from the second coupling body when being coupled to the second coupling body.

The closed protrusion portion is formed on the outer peripheral surface of the first coupling body at a position spaced upward from the insertion groove by a distance corresponding to a spacing distance up to the upper surface of the second coupling body from the insertion protrusion of the second coupling body in a direction in which the outer diameter of the first coupling body is extended so that the lower surface is in contact with the upper surface of the second coupling body.

The second coupling body has a filter seating member which is protruded upward so that the membrane filter is seated on an inner bottoms surface opposite to a periphery of the bottom of the first coupling body in order for the membrane filter to be gripped by the first coupling body inserted into the insertion space.

The first coupling body has a grip protrusion to be protruded to a center side from the periphery of the bottom so as to extend a contact area with the membrane filter seated on the filter seating member.

An end portion of the grip protrusion is protruded further to the center side of the first coupling body than to the filter seating member to prevent the sample from being leaked between the first and second coupling bodies.

In the second coupling body, an outflow port through which the sample passing through the membrane filter is formed at the lower portion, and at least one induction path extended to an inner wall surface from the outflow port is provided to induce the sample passing through the membrane filter to the outflow port, and multiple spacing protrusions protruded upward are formed on an inner bottom surface except for the induction path to prevent the membrane filter from being in close contact with the bottom surface.

The discharge member is protruded downward with respect to the lower surface of the second coupling body, and has an outflow path which is in communication with the outflow port and has an opened lower portion therein.

According to the present invention, there is an advantage in that the separate type bottle top filter device is constituted by the first and second coupling bodies, and the membrane filter which are coupled removably from each other, even though a fault occurs in a part, a part with the fault is replaced and is reusable, and a filter is also easily replaced.

### BRIEF DESCRIPTION OF THE DRAWINGS

FIG. 1 is a perspective view of a separate type bottle top filter device according to an exemplary embodiment of the present invention.

FIG. 2 is an exploded perspective view of the separate type bottle top filter device of FIG. 1.

FIG. 3 is a cross-sectional view of the separate type bottle top filter device of FIG. 1.

FIG. 4 is a partial cross-sectional view of the separate type bottle top filter device of FIG. 1.

FIG. 5 is a plan view of a second coupling body of the separate type bottle top filter device of FIG. 1.

FIG. 6 is a partial cross-sectional view of a separate type bottle top filter device according to another exemplary embodiment of the present invention.

FIG. 7 is a perspective view of the separate type bottle top filter device according to another exemplary embodiment of the present invention.

### DETAILED DESCRIPTION OF THE PREFERRED EMBODIMENT

Hereinafter, a separate type bottle top filter device according to an exemplary embodiment of the present invention will be described with reference to the accompanying drawings. The present invention may have various modifications and various embodiments and specific embodiments will be illustrated in the drawings and described in detail in the specification. However, this does not limit the present invention to specific exemplary embodiments, and it should be understood that the present invention covers all the modifications, equivalents and replacements included within the idea and technical scope of the present invention. While describing each drawing, similar reference numerals are used for similar components. In the accompanying drawings, the sizes of structures are illustrated while being enlarged as compared with actual sizes for clarity of the present invention.

Terms including as first, second, and the like are used for describing various components, but the components should not be limited by the terms. The terms are used only to discriminate one component from another component. For example, a first component may be referred to as a second component, and similarly, the second component may be referred to as the first component without departing from the scope of the present invention.

Terms used in the present application are used only to describe specific exemplary embodiments, and are not intended to limit the present invention. A singular form includes a plural form if there is no clearly opposite meaning in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

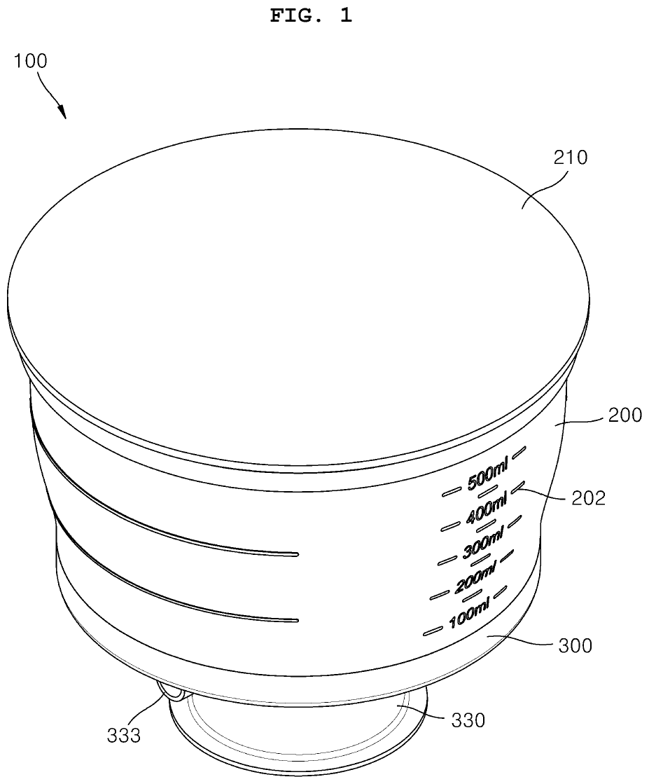

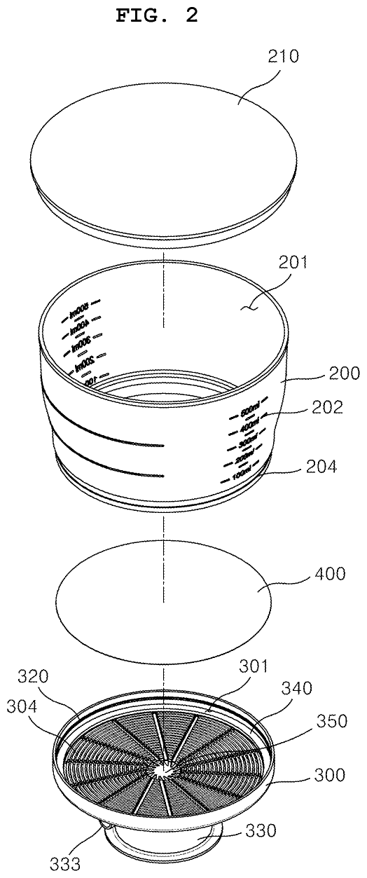

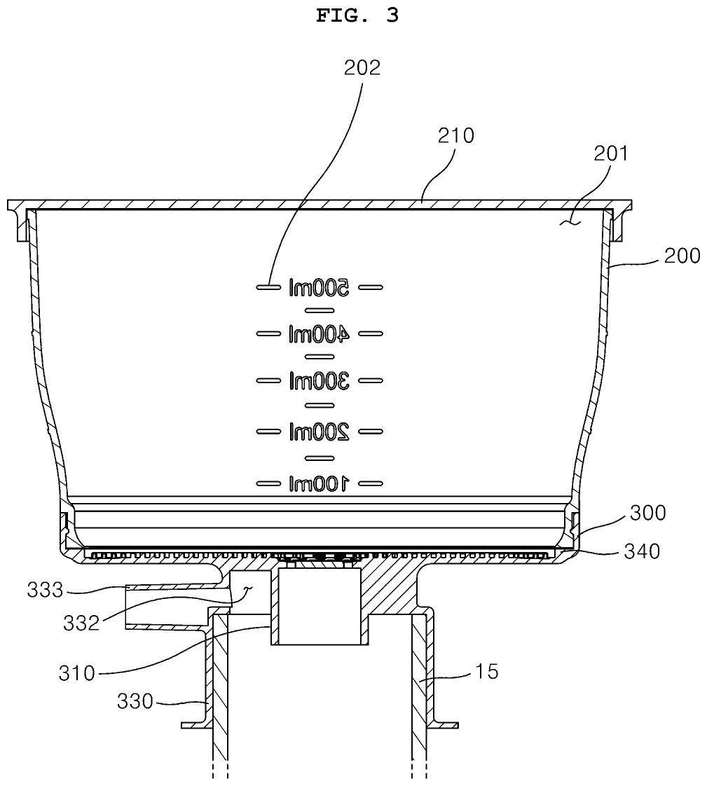

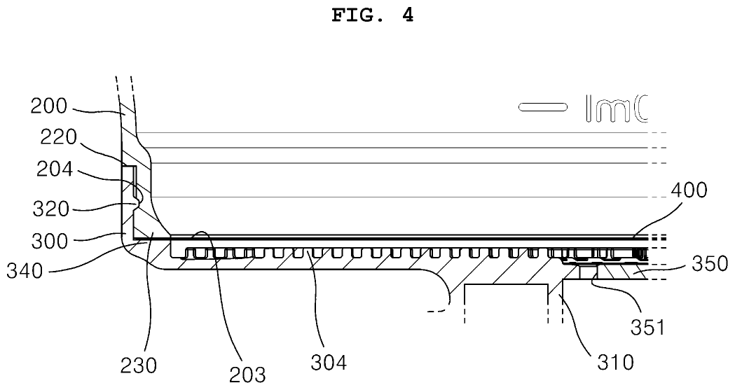

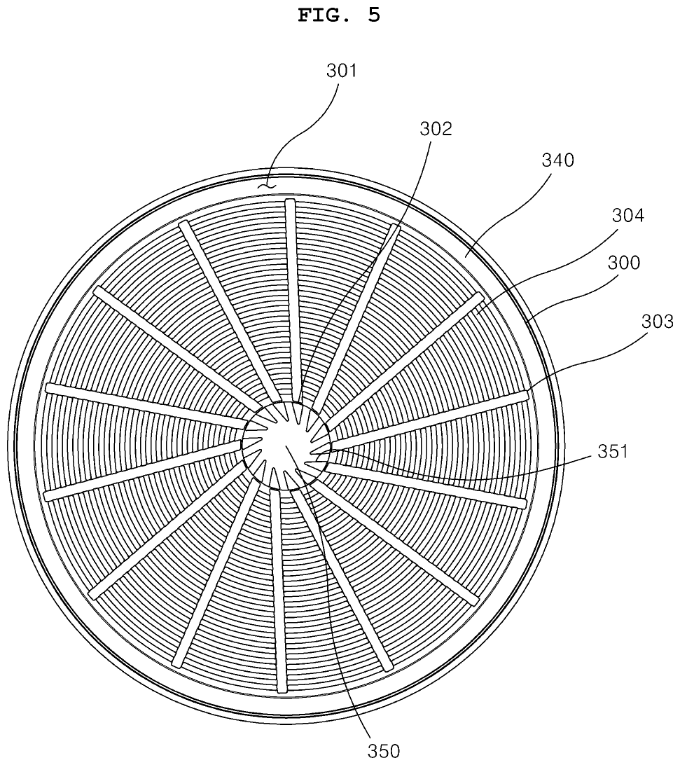

In FIGS. 1 to 5, a separate type bottle top filter device 100 according to an exemplary embodiment of the present invention is illustrated.

Referring to the drawing, the separate type bottle top filter device 100 includes a first coupling body 200 in which an internal space 201 receiving a sample is provided therein, and a discharge port 203 through which the sample is discharged is formed, a second coupling body 300 removably coupled to a lower portion of the first coupling body 200, and having a discharge member 310 for discharging the sample discharged through the first discharge port 203 to one side, and a membrane filter 400 installed between the first and second coupling bodies 200 and 300 to filter a target substance included in the sample discharged by the discharge member 310.

The first coupling body 200 is formed in a cylindrical shape in which the internal space 201 is provided therein, and is formed so that an upper portion is opened to easily input the sample into the internal space 201. Further, in the first coupling body 200, multiple scales 202 are formed on a side to be spaced apart from each other in a vertical direction so as for an operator to recognize the quantity of samples input into the internal space 201. Meanwhile, in the coupling body 200, an external cover 210 is removably coupled to the upper portion to open/close an opened upper surface.

Further, an insertion portion inserted into the second coupling body 300 is provided at the lower portion of the first coupling body 200, and the insertion portion is formed to have an outer diameter smaller than the upper portion of the first coupling body 200. In addition, the discharge port 203 is formed to be penetrated in the vertical direction on a lower surface of the first coupling body 200. The sample in the internal space 201 is discharged downward through the discharge port 203.

Meanwhile, in the first coupling body 200, an insertion groove 204 is formed on an outer peripheral surface of the insertion portion inserted into the inside of the first coupling portion 200. The insertion groove 204 is formed to be inserted inward with respect to the outer peripheral surface of the first coupling body 200 at a position spaced apart by a predetermined distance to an upper side from a lower end of the first coupling body 200. In this case, the insertion groove 204 is preferably formed in the first coupling body 200 in an annular shape in a circumferential direction.

Further, the first coupling body 200 is formed in such a manner that an upper part of the insertion groove 204 has an outer diameter smaller than an inner diameter of the second coupling body 300 so as to easily insert the second coupling body 300.

Meanwhile, when the first coupling body 200 is coupled to the second coupling body 300, a closed protrusion portion 220 is formed on the outer peripheral surface to close an upper portion of a space from the second coupling body 300. The closed protrusion portion 220 is formed on the outer peripheral surface of the first coupling body 200 at a position spaced upward with respect to the insertion groove 204 so that the lower surface may be in contact with the upper surface of the second coupling body 300. That is, the closed protrusion portion 220 may be formed on the outer peripheral surface of the first coupling body 200 at a position spaced upward from the insertion groove 204 by a distance corresponding to a spacing distance up to the upper surface of the second coupling body 300 from the insertion protrusion 320 of the second coupling body 300 to be described below. In this case, the closed protrusion portion 220 is formed to protrude in a direction in which the outer diameter of the first coupling body 200 is extended, and is preferably extended in annular in the shape the circumferential direction. The sample is prevented from being leaked between the first and second coupling bodies 200 and 300.

Further, when the first coupling body 200 is coupled to the second coupling body 300, a grip protrusion 230 is formed at a lower end to extend a contact area with the membrane filter 400 seated inside the second coupling body 300. The grip protrusion 230 is protruded to a center side from a periphery of a lower end portion of the first coupling body 200. In this case, the grip protrusion 230 is preferably extended in the annular shape in the circumferential direction of the first coupling body 200. The first coupling body 200 may more firmly grip the membrane filter 400 by the grip protrusion 230.

The second coupling body 300 is formed in a cylindrical shape in which an insertion space 301 of which upper portion is opened is formed therein so that the lower portion of the first coupling body 200, i.e., the insertion part may be fitted. The second coupling body 300 is formed to have an inner diameter corresponding to the outer diameter of the first coupling body 200 at the insertion groove 204 so as to be in close contact with the outer peripheral surface of the lower portion of the first coupling body 200.

Further, the second coupling body 300 has an outflow port 302 through which the sample passing through the membrane filter 400 formed at the lower portion thereof. The outflow port 302 is penetrated in the vertical direction at the center of the lower surface of the second coupling body 300. The discharge member 310 is protruded downward with respect to the lower surface of the second coupling body 300, and is formed in a cylindrical shape in which an outflow path which is in communication with the outflow port 302 and has an opened lower portion is formed therein.

Meanwhile, the second coupling body 300 has an insertion protrusion 320 formed on the inner peripheral surface to be inserted into the insertion groove 204 of the first coupling body 200 when the first coupling body 200 is inserted into the insertion space 301. The insertion protrusion 320 is protruded to the center side of the insertion space 301 on the inner peripheral surface of the second coupling body 300 at a position spaced upward from a bottom surface of the insertion space 301 by a predetermined distance. Further, the insertion protrusion 320 is extended in the annular shape in the circumferential direction, and is formed in such a manner that an upper surface and a lower surface is inclined to the inner peripheral surface of a second coupling body 300 at a predetermined angle so as to be easily inserted into the insertion groove 204.

Further, the second coupling body 300 has a skirt member 330 formed at the lower portion so as to be coupled to an inlet of the top of the receiving container 15. The skirt member 330 is extended in an annular shape to have a predetermined radius around the outflow port 302 to form an insertion space 332 into which the top of the receiving container 15 may be inserted. The outlet 330 is protruded downward with respect to the lower surface of the second coupling body 300. The top of the receiving container 15 is inserted into a space generated by the skirt member 330, and coupled to the second coupling body 300. In this case, the discharge member 310 of the second coupling body 300 may be formed in such a manner that the bottom is inserted into the receiving container 15 through the inlet of the top of the receiving container 15.

Meanwhile, a suction pipe 333 is installed in the skirt member 330, which may be connected to an air pump (not illustrated). The suction pipe 333 has a path in which air flows therein, and one end of the suction pipe 333 is connected to be in communication with the insertion space 332. Further, the other end of the suction pipe 333 is opened to be in communication with a connection pipe (not illustrated) connected to the air pump. The air pump is connected to the suction pipe 333 through the connection pipe as described above, and provides a suction force to the inside of the skirt member 330. The sample in the first coupling body 200 is inserted into the receiving container 15 by passing through the membrane e filter 400 while air in the insertion space 332 of the skirt member 330 and the internal space 201 of the first coupling body 200 is discharged to the outside by the suction force provided through the air pump.

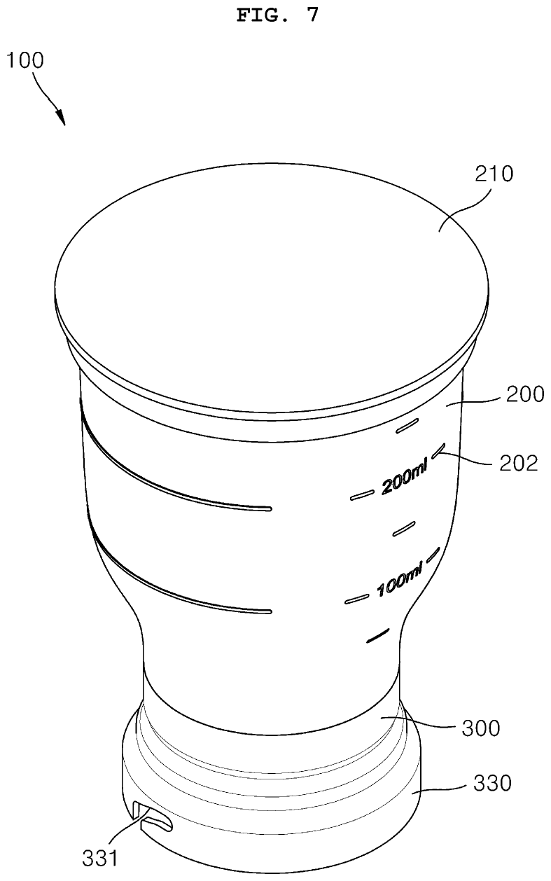

Meanwhile, as illustrated in FIG. 7, the skirt member 330 has a fastening groove 331 so that a fixation protrusion (not illustrated) formed on the outer peripheral surface of the top of the receiving container 15 is inserted. The fastening groove 331 is extended upward from the bottom of the skirt member 330, and the top is extended to be curved in the circumferential direction.

Further, the second coupling body 300 has a filter seating member 340 therein so that the membrane filter 400 is gripped by the first coupling body 200 inserted into the insertion space 301. The filter seating member 340 is formed on an inner bottom surface opposite to the periphery of the bottom of the first coupling body 200 inserted into the insertion space 301, and protruded upward with respect to the bottom surface of the insertion space 301 so that an upper surface is in contact with the bottom of the first coupling body 200. Here, the filter seating member 340 is adjacent to the inner surface of the second coupling body 300, and extended in the annular shape in the circumference direction, and the upper surface is preferably formed to be flat so as to support the lower surface of the membrane filter 400. When the first coupling body 200 is inserted into the second coupling body 300, the membrane filter 400 is gripped by the bottom of the first coupling body 200 and the filter seating member 340, to firmly fix the membrane filter 400 to the inside of the second coupling body 300. In this case, the upper surface of the filter seating member 340 is preferably formed to have an area corresponding to the bottom of the first coupling body 200 and the grip protrusion 230.

In addition, multiple induction paths 303 extended to an inner wall surface from the outflow port 302 are provided in the second coupling member 300 to induce the sample passing through the membrane filter 400 to the outflow port 302. The induction path 303 is linearly extended so that one end is adjacent to the outflow port 302 and the other end is adjacent to the filter seating member 340. Here, although not illustrated in the drawing, the induction path 303 may also be inserted by a predetermined depth downward with respect to the bottom surface of the second coupling body 300. Multiple induction paths 303 are arranged radially around the outflow port 302. Meanwhile, in an illustrated example, a structure in which 14 induction paths 303 are formed is illustrated, but is not limited thereto, but 13 or less or 15 or more induction paths 303 may also be provided according to a size of the second coupling body 300. The sample passing through the membrane filter 400 may be easily induced to the outflow port 302 by the induction path 303.

Meanwhile, in the induction path 303, a virtual line extended in a longitudinal direction is preferably formed to be spaced apart from the center of the outflow port 302 so that the sample discharged through the outflow port 302 moves downward while pivoting along the inner wall surface of the discharge member 310.

Further, the second coupling body 300 has multiple spacing protrusions 304 therein in order to prevent the membrane filter 400 from being in close contact with the bottom surface. The spacing protrusion 304 is protruded upward on the inner bottom surface of the second coupling body 300 except for the induction path 303. In this case, multiple spacing protrusions 304 are arranged to be spaced apart from each other, and preferably formed between the induction paths 303. Since the membrane filter 400 is supported to be spaced apart upward from the bottom surface of the second coupling body 300 by the spacing protrusions 304, the sample may more smoothly pass through the membrane filter 400.

Meanwhile, a guide member 350 guiding the sample discharged through the outflow port 302 is installed inside the discharge member 310 of the second coupling body 300. The guide member 350 has multiple induction holes 351 which is installed inside the discharge member 310 at a position spaced apart downward from the bottom surface of the insertion space 301 of the second coupling body 300, and to be passed by the sample. In this case, the induction hole 351 is penetrated in the vertical direction, and preferably formed at a position adjacent to the inner wall surface of the discharge member 310 so as to induce the sample to the inner wall surface of the discharge member 310. Further, each induction hole 351 is formed in the guide member 350 at a position adjacent to one end portion of the induction path 303 so as to easily induce the sample introduced into the outflow port 302 along the induction path 303. The sample passing through the outflow port 302 is induced to the inner wall surface of the discharge member 310 by the guide member 350, so the sample may more smoothly flow out to the receiving container 15. Meanwhile, although not illustrated in the drawing, multiple guide protrusions may be formed on the inner wall surface of the discharge member 310 so as to guide the sample passing through the guide member 350. The guide protrusion is extended in the vertical direction so that a top is adjacent to the induction hole 351 of the guide member 350 and a bottom is adjacent to the bottom of the discharge member 310. In this case, the guide protrusion may also be extended in a spiral shape to induce the sample to pivot along the inner wall surface of the discharge member 310.

The membrane filter 400 is formed in a disc shape having a predetermined thickness to be inserted into the second coupling body 300. In this case, the membrane filter 400 is preferably formed to have an outer diameter corresponding to the inner diameter of the second coupling body 300 so that a periphery is seated on the filter seating member 340 and gripped to the first coupling body 200. Since the membrane filter 400 is a membrane generally used to detect a target substance such as an antibody in the sample, a detailed description is omitted.

The separate type bottle top filter device 100 according to the present invention configured as described above has an advantage in that the separate type bottle top filter device is constituted by the first and second coupling bodies 200 and 300, and the membrane filter 400 which are coupled removably from each other, even though a fault occurs in a part, a part with the fault is replaced and is reusable, and a filter is also easily replaced.

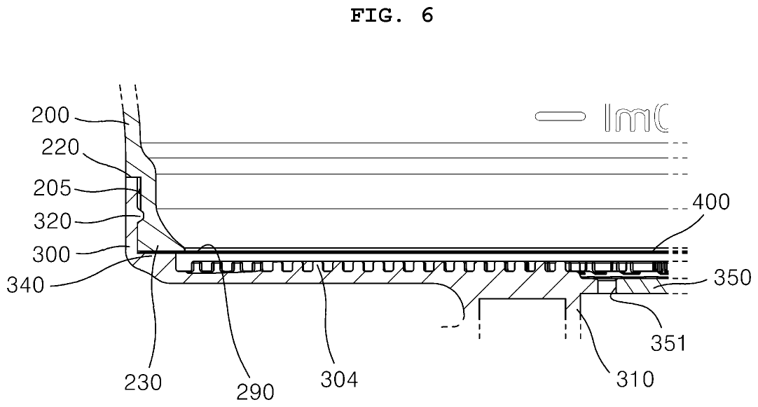

Meanwhile, in FIG. 6, a grip protrusion 290 of the separate type bottle top filter device 100 according to another exemplary embodiment of the present invention is illustrated.

Elements that perform the same function as in the previously illustrated drawings are denoted by the same reference numerals.

Referring to the drawing, an end portion of the grip protrusion 290 is protruded further to the center side of the first coupling body 200 than to the filter seating member 340 in order to prevent the sample from being leaked between the first and second coupling bodies 200 and 300. The end portion of the grip protrusion 290 is protruded further than the filter seating member 340, which interferes with the sample which flows to the membrane filter 400 to induce the sample to the induction path 303. Therefore, the quantity of samples introduced between the grip protrusion 290 and the filter seating member 340 to prevent the sample from being leaked between the first and second coupling bodies 200 and 300. Further, the grip protrusion 290 supports the upper portion of the membrane filter 400 with the end portion which is protruded further than the filter seating member 340 to prevent the membrane filter 400 from being floated and firmly support the membrane filter 400.

The description of the presented exemplary embodiments is provided so that those skilled in the art use or implement the present invention. Various modifications of the exemplary embodiments will be apparent to those skilled in the art and general principles defined herein can be applied to other exemplary embodiments without departing from the scope of the present invention. Therefore, the present invention is not limited to the exemplary embodiments presented herein, but should be analyzed within the widest range which is coherent with the principles and new features presented herein.

What is claimed is:

1. A separate type bottle top filter device comprising:
a first coupling body in which an internal space receiving a sample is provided therein, and a discharge port through which the sample is discharged is formed;
a second coupling body removably coupled to a lower portion of the first coupling body, and having a discharge member for discharging the sample discharged through the first discharge port to one side; and
a membrane filter installed between the first and second coupling bodies to filter a target substance included in the sample discharged by the discharge member.

2. The separate type bottle top filter device of claim 1, wherein the second coupling body is formed in which an insertion space of which upper portion is opened is formed therein so that the lower portion of the first coupling body is fitted.

3. The separate type bottle top filter device of claim 2, wherein the first coupling body is formed in an insertion groove on an outer peripheral surface of a lower portion inserted into the first coupling body, and
the second coupling body has an insertion protrusion formed on an inner peripheral surface so as to be inserted into the insertion groove when the first coupling body is inserted into the insertion space.

4. The separate type bottle top filter device of claim 3, wherein the first coupling body is formed so that an upper part of the insertion groove has an outer diameter smaller than an inner diameter of the second coupling body to be easily inserted by the second coupling body.

5. The separate type bottle top filter device of claim 4, wherein the first coupling body has a closed protrusion portion formed on the outer peripheral surface so as to close a space from the second coupling body when being coupled to the second coupling body.

6. The separate type bottle top filter device of claim 5, wherein the closed protrusion portion is formed on the outer peripheral surface of the first coupling body at a position spaced upward from the insertion groove by a distance corresponding to a spacing distance up to the upper surface of the second coupling body from the insertion protrusion of the second coupling body in a direction in which the outer diameter of the first coupling body is extended so that the lower surface is in contact with the upper surface of the second coupling body.

7. The separate type bottle top filter device of claim 2, wherein the second coupling body has a filter seating member which is protruded upward so that the membrane filter is seated on an inner bottoms surface opposite to a periphery of the bottom of the first coupling body in order for the membrane filter to be gripped by the first coupling body inserted into the insertion space.

8. The separate type bottle top filter device of claim 7, wherein the first coupling body has a grip protrusion to be protruded to a center side from the periphery of the bottom so as to extend a contact area with the membrane filter seated on the filter seating member.

9. The separate type bottle top filter device of claim 8, wherein an end portion of the grip protrusion is protruded further to the center side of the first coupling body than to the filter seating member to prevent the sample from being leaked between the first and second coupling bodies.

10. The separate type bottle top filter device of claim 2, wherein in the second coupling body, an outflow port through which the sample passing through the membrane filter is formed at the lower portion, and at least one induction path extended to an inner wall surface from the outflow port is provided to induce the sample passing through the membrane filter to the outflow port, and multiple spacing protrusions protruded upward are formed on an inner bottom surface except for the induction path to prevent the membrane filter from being in close contact with the bottom surface.

11. The separate type bottle top filter device of claim 10, wherein the discharge member is protruded downward with respect to the lower surface of the second coupling body, and has an outflow path which is in communication with the outflow port and has an opened lower portion therein.
